(19) United States
(12) Patent Application Publication
(10) Pub. No.: US 2010/0089530 A1
(43) Pub. Date: Apr. 15, 2010

(54) METHODS OF FORMING FLUID BARRIERS OVER POWDER METAL PARTS AND INCREASING WEAR RESISTANCE THEREOF

(75) Inventor: Shekhar G. Wakade, Grand Blanc, MI (US)

Correspondence Address: DINSMORE & SHOHL LLP, FIFTH THIRD CENTER, ONE SOUTH MAIN STREET, SUITE 1300, DAYTON, OH, 45402, US

(73) Assignee: GM GLOBAL TECHNOLOGY OPERATIONS, INC., Detroit, MI (US)

(21) Appl. No.: 12/250,280

(22) Filed: Oct. 13, 2008

(51) Int. Cl. B32B 37/12; B05D 3/02; B05D 1/38

(52) U.S. Cl. 156/324.4; 427/374.1; 427/532

(57) ABSTRACT

A method of forming a fluid barrier over a powder metal part. The method includes providing a molded powder metal part and applying a fluid impenetrable material to a designated portion of the molded powder metal part to form a molded powder metal complex. Thereafter, the method includes sintering the molded powder metal complex to where the fluid impenetrable material and the designated portion of the molded powder metal part at least partially integrate. Further, the method includes cooling the molded powder metal complex such that the fluid impenetrable material forms a fluid barrier over the designated portion of the molded powder metal part. The method may further include anodizing the fluid impenetrable material at least partially integrated with the designated portion of the molded powder metal part and forming the fluid barrier over the designated portion so as to increase wear resistance thereof.

### BACKGROUND

The present invention relates generally to improved durability in metal components, and more particularly to methods of forming fluid barriers over powder metal parts and increasing wear resistance thereof.

Camshaft caps fix the position of the camshaft rod and prevent lateral and vertical shifting thereof during engine operation. Camshaft thrust faces of rotating cams may rub against thrust grooves of the camshaft cap. Since, typically, the camshaft caps are made from powder metal aluminum alloy, a less expensive, but less resilient material, the thrust grooves of the camshaft caps tend to deteriorate due to repeated rubbing action against the camshaft thrust faces of the cams. Excessive wear of the thrust grooves of the camshaft caps can lead to wobbling of the rotating cams, resulting in camshaft position sensor fault and frustration for the driver of the vehicle. Approaches of the prior art to prevent excessive wear of camshaft caps include changes to methods of grinding the camshaft thrust faces of the cams, changes to the surface finish of the camshaft thrust faces, and heat treatments, such as T6 treatment, for the camshaft caps, but such approaches generally are costly and have produced only limited success and inconsistent results.

### SUMMARY

It is against the above background that the present invention provides methods of forming fluid barriers over powder metal parts and increasing wear resistance thereof.

In accordance with one exemplary embodiment, a method of forming a fluid barrier over a powder metal part comprises: providing a molded powder metal part; applying a fluid impenetrable material to a designated portion of the molded powder metal part to form a molded powder metal complex; sintering the molded powder metal complex to where the fluid impenetrable material and the designated portion of the molded powder metal part at least partially integrate; and cooling the molded powder metal complex such that the fluid impenetrable material forms an integrated fluid barrier over the designated portion of the molded powder metal part.

Optionally, the fluid impenetrable material may comprise a thickness of up to about 2.0 millimeters. The fluid impenetrable material may comprise an aluminum-based material or an iron-based material. The aluminum-based fluid impenetrable material may be anodized selectively after it forms an integrated fluid barrier over the designated portion of the molded powder metal part so as to increase wear resistance thereof. The molded powder metal part may comprise a camshaft cap and the designated portion thereof may comprise a thrust groove of the camshaft cap.

In accordance with another exemplary embodiment, a method of forming a fluid barrier over a powder metal part comprises: providing a molded powder metal part; and applying under pressure a fluid impenetrable material, such as a metal foil, that has a pressure sensitive adhesive on the underside thereof to a designated portion of the molded powder metal part so as to form an integrated fluid barrier over the designated portion of the molded powder metal part.

Optionally, the fluid impenetrable material may comprise a thickness of up to about 2.0 millimeters. The fluid impenetrable material may comprise an aluminum-based material. The method may further comprise anodizing a top surface of the aluminum-based fluid impenetrable material applied to the designated portion of the molded powder metal part forming the integrated fluid barrier over the designated portion of the molded powder metal part so as to increase wear resistance thereof. The fluid impenetrable material alternatively may be a foil tape comprising a thickness of up to about 0.25 millimeters that may maintain its adhesion to the molded powder metal part through temperature variations ranging from between about −60 degrees Fahrenheit and about 600 degrees Fahrenheit. The fluid impenetrable material may be provided in one or more dimensions complementary to one or more dimensions of the designated portion of the molded powder metal part prior to application of the fluid impenetrable material thereto. The molded powder metal part may comprise a camshaft cap and the designated portion thereof may comprise a thrust groove of the camshaft cap.

In accordance with yet another exemplary embodiment, a method of forming a fluid barrier over a powder metal aluminum camshaft cap and increasing the wear resistance thereof comprises: providing a powder metal aluminum camshaft cap; applying a fluid impenetrable material to a thrust groove of the powder metal aluminum camshaft cap to form a camshaft cap complex, such as through a pressing or coining-like operation followed by a sintering operation of the camshaft cap complex to where the fluid impenetrable material and the thrust groove of the powder metal aluminum camshaft cap at least partially integrate, such that the fluid impenetrable material, such as a metal sheet of suitable size, thickness, and geometry, forms an integrated fluid barrier over the thrust groove of the powder metal aluminum camshaft cap. Thereby, the thrust groove of the powder metal aluminum camshaft cap is now both fluid impenetrable and capable of being anodized, wherein the anodized fluid impenetrable material can provide desired wear resistance of the thrust groove. As such, the method may further comprise anodizing a top surface of the fluid impenetrable material at least partially integrated with the thrust groove of the powder metal aluminum camshaft cap and forming the integrated fluid barrier over the thrust groove so as to increase wear resistance thereof.

Optionally, the fluid impenetrable material may comprise an aluminum-based material. The aluminum-based fluid impenetrable material may comprise a thickness of between about 0.25 millimeters and about 2.0 millimeters. The fluid impenetrable material may be provided in one or more dimensions complementary to one or more dimensions of the thrust groove of the powder metal aluminum camshaft cap prior to application of the fluid impenetrable material thereto. The application of the fluid impenetrable material to the thrust groove may be accomplished by using a single press and sintering operation or, if needed or desired, by employing a double press and double sintering operation, wherein the second pressing operation may be used for pressing a metal sheet of suitable dimensions into the thrust groove of the powder metal aluminum camshaft cap.

### BRIEF DESCRIPTION OF THE DRAWINGS

The following detailed description of specific embodiments can be best understood when read in conjunction with the following drawings, where like structure is indicated with like reference numerals and in which:

FIG. 1A is an illustration of a view of a camshaft cap according to one embodiment of the present invention;

FIG. 1B is an illustration of a magnified view of a thrust groove of the camshaft cap illustrated in FIG. 1A;

FIG. 2A is an illustration of a side cross-sectional view of a fluid impenetrable material according to another embodiment of the present invention; and

FIG. 2B is an illustration of a side cross-sectional view of a fluid impenetrable material comprising a pressure sensitive adhesive according to another embodiment of the present invention.

The embodiments set forth in the drawings are illustrative in nature and are not intended to be limiting of the embodiments defined by the claims. Moreover, individual aspects of the drawings and the embodiments will be more fully apparent and understood in view of the detailed description that follows.

### DETAILED DESCRIPTION

Fluid barriers formed over one or more exterior surfaces of powder metal parts may prevent fluid seepage through these exterior surfaces of powder metal parts. Thereby, corrosion of powder metal parts that frequently is attributed to fluid exposure and seepage is significantly inhibited by the fluid barrier. In addition, wear resistance of powder metal parts may be enhanced through anodizing of fluid impenetrable materials forming the fluid barriers. As such, the functional life of powder metal parts may be greatly enhanced.

In one exemplary embodiment, a method of forming a fluid barrier over a powder metal part first comprises providing a molded powder metal part. The molded powder metal part may be manufactured by a same party performing the method or may be acquired from a third party. The molded powder metal part generally is provided in a molded form appropriate for final use. The molded powder metal part may comprise any one or more components formed through one or more of any variety of powder metal forming processes. Once the molded powder metal part is provided, the method comprises applying a fluid impenetrable material to a designated portion of the molded powder metal part. It is contemplated that the fluid impenetrable material may comprise a density higher than a density of the molded powder metal part. As such, with the application of the fluid impenetrable material over the designated portions of the molded powder metal part, a higher density fluid impenetrable material may prevent seepage of fluid into a lower density molded powder metal part.

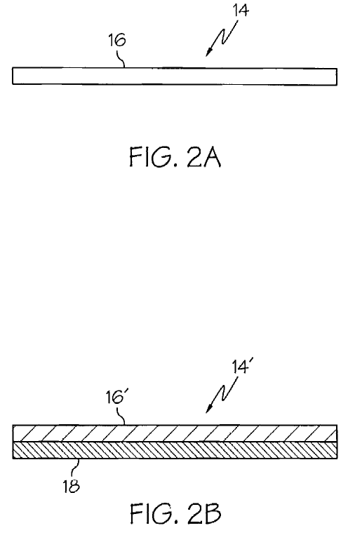

The fluid impenetrable material 14/14′, shown in FIGS. 2A and 2B respectively, may comprise at least one of an aluminum-based material, an iron-based material, or other metal-based material. More particularly, the fluid impenetrable material 14/14′ may be an aluminum-based foil, an iron-based foil, or other metal-based foil. The fluid impenetrable material 14/14′ may comprise any thickness sufficient to perform the purposes stated herein. For example, but not by way of limitation, the fluid impenetrable material 14/14′ may comprise a thickness of up to about 2.0 millimeters, or even up to about 3.0 millimeters or greater. Meanwhile, the designated portion of the molded powder metal part generally comprises an exterior surface thereof. As used herein, “an exterior surface” refers to at least a portion of the exposed surface of a molded powder metal part that may be subjected to fluids and/or frictional contact. The exterior surface of the designated portion of the molded powder metal part generally comprises a recessed depth, with respect to another exterior surface of the molded powder metal part, in which the fluid impenetrable material may be applied. As such, the fluid impenetrable material 14/14′ generally is applied to a recessed portion of the exterior surface of the molded powder metal part; however, the fluid impenetrable material need not necessarily be applied to a recessed portion of an exterior surface of a molded powder metal part.

The fluid impenetrable material 14/14′ may be applied to the designated portion of the molded powder metal part through one or more of any variety of processes. For example, in one embodiment, the fluid impenetrable material 14/14′ is applied to the designated portion of the molded powder metal part through a coining process. In another exemplary embodiment, the fluid impenetrable material 14/14′ is applied to the designated portion of the molded powder metal part through a relatively low-pressure pressing process. Regardless of how the fluid impenetrable material 14/14′ may be applied to the designated portion of the molded powder metal part, the molded powder metal part and the applied fluid impenetrable material form a molded powder metal complex.

When a fluid impenetrable material 14, which lacks an adhesive backing, is applied to the designated portion of the molded powder metal part to form the molded powder metal complex, the method generally further comprises sintering the molded powder metal complex. The molded powder metal complex may be sintered so as to ensure sufficient bonding between the fluid impenetrable material 14 and the designated portion of the molded powder metal part thereunder. The sintering temperature used may depend upon the powder metal alloy system formulation employed in forming the molded powder metal part. For example, with respect to aluminum-based alloys, the sintering temperature generally is at least about 900 degrees Fahrenheit, and generally even often above about 1000 degrees Fahrenheit. Further, the fluid impenetrable material 14 selected may depend upon the base powder metal component chemistry of the molded powder metal part, so as to allow bonding to take occur between the fluid impenetrable material 14 and the molded powder metal part while maintaining respective structural shapes thereof, unlike materials used for infiltration. As such, the fluid impenetrable material 14 generally has a higher melting point in comparison to that of the powder metal forming the molded powder metal parts so that the fluid impenetrable material 14 does not melt during the sintering operation and is able to maintain its fluid impenetrable characteristics and prevent fluid seepage into the designated portion of the molded powder metal part. In addition, to facilitate and ensure sufficient bonding between the fluid impenetrable material 14 and the molded powder metal part, an adequate load pressure may be applied, via a pressing operation, at an appropriate location of the molded powder metal complex, such as the top surface 16 of the fluid impenetrable material 14 applied to the designated portion of the molded powder metal part, during the sintering operation.

Thereafter, the method comprises cooling the molded powder metal complex. Thereby, the fluid impenetrable material 14 and the designated portion of the molded powder metal part bond such that the fluid impenetrable material 14 forms an integrated fluid barrier over the designated portion of the molded powder metal part. The molded powder metal complex may be cooled to any appropriate temperature sufficient to achieve the at least partial integration of the fluid impenetrable material 14 and the designated portion of the molded powder metal part. This may include cooling the molded powder metal complex to a room temperature, or other ambient temperature, or cooling to a temperature higher or lower than that of a surrounding environment.

In another exemplary embodiment, a method of forming a fluid barrier over a powder metal part comprises providing a molded powder metal part and applying under pressure a fluid impenetrable material 14′ to a designated portion of the molded powder metal part. As such, the applied fluid impenetrable material 14′ forms a fluid barrier over the designated portion of the molded powder metal part. As shown in FIG. 2B, the fluid impenetrable material 14′ comprises a pressure sensitive adhesive 18 that adheres to the designated portion of the molded powder metal part with application of the fluid impenetrable material 14′ thereto.

The fluid impenetrable material 14′ may be a foil tape and may comprise a thickness of up to about 0.25 millimeters. The foil tape generally may maintain its adhesion to the molded powder metal part through temperature variations ranging from between about −60 degrees Fahrenheit and about 600 degrees Fahrenheit.

Generally, the fluid impenetrable materials 14/14′ are provided in one or more dimensions complementary to one or more dimensions of the designated portions of the molded powder metal parts prior to application of the fluid impenetrable materials 14/14′ thereto. As such, the fluid impenetrable materials 14/14′ may comprise dimensions that complement those of the designated portions of the molded powder metal parts. Providing the desired dimensions to the fluid impenetrable materials 14/14′ may be achieved during a manufacturing process thereof, immediately prior to application to the designated portions of the molded powder metal parts, or otherwise. In addition, the desired dimensions may be provided to the fluid impenetrable materials 14/14′ through mechanical or manual cutting or otherwise.

Further, as aluminum and aluminum-based alloys are materials generally suitable for anodizing processes, the aluminum-based fluid impenetrable material 14/14′ may be anodized to increase wear resistance thereof. For example, but not by way of limitation, if a density of a molded powder metal part is less than 95% of theoretical, then an aluminum-based fluid impenetrable material 14/14′ may be applied to a designated portion of the molded powder metal part through a sintering operation or a pressing operation. Thereafter, a top surface 16/16′ of the fluid impenetrable material 14/14′ may be anodized so as to further increase wear resistance of the designated portion. Anodizing a designated portion of a powder metal part protected by a fluid barrier may depend on the molded powder metal part performance requirements including, but not limited to, inhibiting corrosion, higher surface hardness, improve lubrication retention, and enhanced wear resistance of the molded powder metal parts. Generally, but not necessarily, aluminum-based fluid impenetrable materials 14/14′ appropriate for anodizing respectively comprise a thickness of between about 0.25 millimeters and about 3.0 millimeters, or greater. The actual thickness of the fluid impenetrable material 14/14′ may depend on a specific application of the molded powder metal part and a fluid impenetrable material thickness that generally is needed to adequately perform an anodizing process.

In one exemplary embodiment, the aluminum-based fluid impenetrable materials 14/14′ may be anodized prior to application of the aluminum-based fluid impenetrable materials 14/14′ to the designated portions of the molded powder metal parts, provided the anodized fluid impenetrable material 14/14′ is not likely to be cracked or damaged in any way due to pressing, sintering, bonding, and/or cooling operations. Alternatively, in another exemplary embodiment, methods of forming fluid barriers over powder metal parts may further comprise anodizing respective top surfaces 16/16′ of the aluminum-based fluid impenetrable materials 14/14′ forming the integrated fluid barriers over the designated portions of the molded powder metal parts. Such anodizing of the aluminum-based fluid impenetrable materials 14/14′ may be done selectively such that the molded powder metal part is not anodized as well.

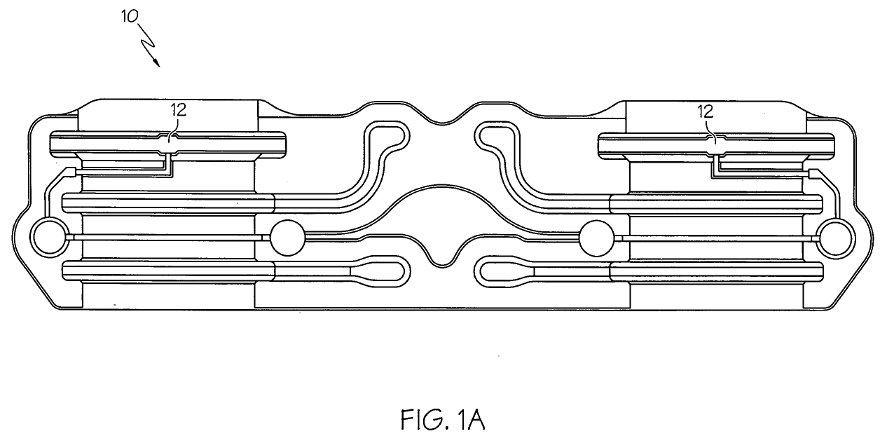

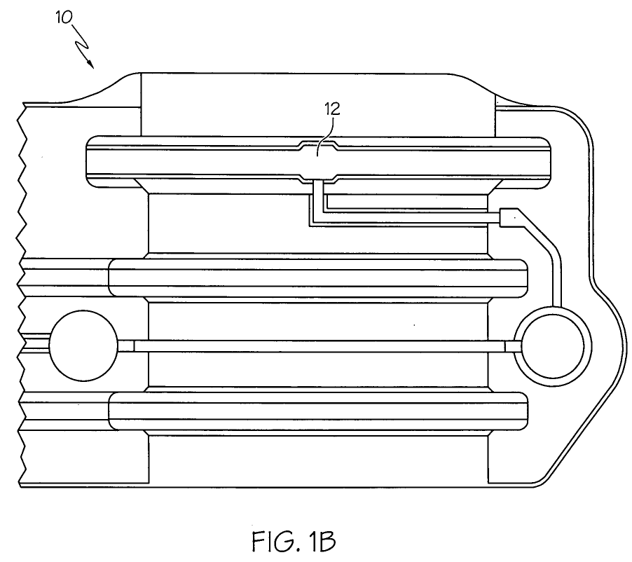

As mentioned above, it is contemplated that the molded powder metal part may comprise any one or more components formed through one or more of any variety of powder metal forming processes. In one exemplary embodiment, shown in FIGS. 1A and 1B, the molded powder metal part comprises a camshaft cap 10 and the designated portion of the molded powder metal part comprises a thrust groove 12 formed in the molded powder metal camshaft cap 10. Generally, but not necessarily, the molded powder metal camshaft cap comprises an aluminum-based material, such as, but not limited to, an aluminum alloy. With completion of an embodiment of a method of forming a fluid barrier over a powder metal part, a thrust groove 12 of a camshaft cap 10 may be protected from fluid seepage by the application of a fluid impenetrable material thereto.

Applying a fluid impenetrable material, with potential anodizing thereof, to powder metal camshaft caps produces camshaft caps having desirable tribological properties for engine operation, generally regardless of the quality of the base powder metal or powder metal alloy used to form the camshaft cap. As described herein, an aluminum-based fluid impenetrable material, or other metal-based fluid impenetrable material, of desired thickness can be applied to a thrust groove, which may then be selectively anodized to further inhibit corrosion and increase hardness thereof and thereby increase wear resistance of the thrust groove of the camshaft cap. As such, less expensive base powder metals and/or powder metal alloys, which typically have more porous exterior surfaces, may be used to form powder metal camshaft caps that may be at least partially covered with a fluid impenetrable material to provide a fluid barrier, which further may be anodized to increase wear resistance thereof, and, thus, increase the functional life of the powder metal camshaft caps. In addition, as powder metal camshaft caps generally are produced by a number of manufacturers using different quality powder metals and production methods and, thus, tend to vary in wear resistance, wear resistance of various powder metal camshaft caps can be made relatively consistent and predictable through application of embodiments of the methods described herein.

It is noted that recitations herein of a component of an embodiment being “configured” in a particular way or to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that terms like “generally” and “typically,” when utilized herein, are not utilized to limit the scope of the claimed embodiments or to imply that certain features are critical, essential, or even important to the structure or function of the claimed embodiments. Rather, these terms are merely intended to identify particular aspects of an embodiment or to emphasize alternative or additional features that may or may not be utilized in a particular embodiment.

For the purposes of describing and defining embodiments herein it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described embodiments of the present invention in detail, and by reference to specific embodiments thereof, it will be apparent that modifications and variations are possible without departing from the scope of the embodiments defined in the appended claims. More specifically, although some aspects of embodiments of the present invention are identified herein as preferred or particularly advantageous, it is contemplated that the embodiments of the present invention are not necessarily limited to these preferred aspects.

What is claimed is:

1. A method of forming a fluid barrier over a powder metal part, the method comprising:
providing a molded powder metal part;
applying a fluid impenetrable material to a designated portion of the molded powder metal part to form a molded powder metal complex;
sintering the molded powder metal complex to where the fluid impenetrable material and the designated portion of the molded powder metal part at least partially integrate; and
cooling the molded powder metal complex such that the fluid impenetrable material forms an integrated fluid barrier over the designated portion of the molded powder metal part.

2. The method of claim 1, wherein the fluid impenetrable material comprises a thickness of up to about 2.0 millimeters.

3. The method of claim 1, wherein the fluid impenetrable material comprises an aluminum-based material.

4. The method of claim 3, wherein the aluminum-based fluid impenetrable material is anodized prior to application to the designated portion of the molded powder metal part so as to increase wear resistance thereof.

5. The method of claim 3, wherein the method further comprises anodizing a top surface of the aluminum-based fluid impenetrable material at least partially integrated with the designated portion of the molded powder metal part and forming the integrated fluid barrier over the designated portion so as to increase wear resistance thereof.

6. The method of claim 1, wherein the fluid impenetrable material comprises an iron-based material.

7. The method of claim 1, wherein the molded powder metal part comprises a camshaft cap and the designated portion thereof comprises a thrust groove of the camshaft cap.

8. A method of forming a fluid barrier over a powder metal part, the method comprising:
providing a molded powder metal part; and
applying under pressure a fluid impenetrable material to a designated portion of the molded powder metal part so as to form an integrated fluid barrier over the designated portion of the molded powder metal part, wherein the fluid impenetrable material comprises a pressure sensitive adhesive that adheres to the designated portion of the molded powder metal part with application of the fluid impenetrable material thereto.

9. The method of claim 8, wherein the fluid impenetrable material comprises a thickness of up to about 2.0 millimeters.

10. The method of claim 8, wherein the fluid impenetrable material comprises an aluminum-based material.

11. The method of claim 10, wherein the aluminum-based fluid impenetrable material is anodized prior to its application to the designated portion of the molded powder metal part.

12. The method of claim 10, wherein the method further comprises anodizing a top surface of the aluminum-based fluid impenetrable material applied to the designated portion of the molded powder metal part and forming the integrated fluid barrier over the designated portion of the molded powder metal part so as to increase wear resistance thereof.

13. The method of claim 10, wherein the fluid impenetrable material is a foil tape comprising a thickness of up to about 0.25 millimeters.

14. The method of claim 13, wherein the pressure sensitive adhesive of the foil tape maintains its adhesion to the molded powder metal part through temperature variations ranging from between about −60 degrees Fahrenheit and about 600 degrees Fahrenheit.

15. The method of claim 10, wherein the fluid impenetrable material is provided in one or more dimensions complementary to one or more dimensions of the designated portion of the molded powder metal part prior to application of the fluid impenetrable material thereto.

16. The method of claim 10, wherein the molded powder metal part comprises a camshaft cap and the designated portion thereof comprises a thrust groove of the camshaft cap.

17. A method of forming a fluid barrier over a powder metal aluminum camshaft cap and increasing the wear resistance thereof, the method comprising:
providing a powder metal aluminum camshaft cap;
applying a fluid impenetrable material to a thrust groove of the powder metal aluminum camshaft cap to form a camshaft cap complex;
sintering the camshaft cap complex to where the fluid impenetrable material and the thrust groove of the powder metal aluminum camshaft cap at least partially integrate;
cooling the camshaft cap complex such that the fluid impenetrable material forms an integrated fluid barrier over the thrust groove of the powder metal aluminum camshaft cap; and
anodizing a top surface of the fluid impenetrable material at least partially integrated with the thrust groove of the powder metal aluminum camshaft cap and forming the integrated fluid barrier over the thrust groove so as to increase wear resistance thereof.

18. The method of claim 17, wherein the fluid impenetrable material comprises an aluminum-based material.

19. The method of claim 18, wherein the aluminum-based fluid impenetrable material comprises a thickness of between about 0.25 millimeters and about 2.0 millimeters.

20. The method of claim 17, wherein the fluid impenetrable material is provided in one or more dimensions complementary to one or more dimensions of the thrust groove of the powder metal aluminum camshaft cap prior to application of the fluid impenetrable material thereto.
